(19) United States
(12) Patent Application Publication
(10) Pub. No.: US 2026/0154895 A1
(43) Pub. Date: Jun. 4, 2026

(54) SYSTEMS AND METHODS FOR IMMERSIVE WEB CONTENT CREATION

(71) Applicant: Codazen, Irvine, CA (US)

(72) Inventors: Michael Henry Merchant, Rancho Santa Margarita, CA (US); Mounir Semaan, Irvine, CA (US); Chandler Van Scoy, Irvine, CA (US); Aditya Mallampalli, Irvine (IN)

(73) Assignee: Codazen, Irvine, CA (US)

(21) Appl. No.: 19/346,236

(22) Filed: Sep. 30, 2025

Related U.S. Application Data
(60) Provisional application No. 63/701,519, filed on Sep. 30, 2024.

(51) Int. Cl. G06T 15/00; G06T 19/00

(52) U.S. Cl. CPC G06T 15/005; G06T 19/006

(57) ABSTRACT

Systems and methods for an author-once, render-anywhere immersive content platform are disclosed. An authoring service generates a runtime-agnostic universal schema defining assets, panels, and triggers for two-dimensional (2D), three-dimensional (3D), and blended 2D-to-3D presentations. On a client device, a runtime selector probes device capabilities to select a renderer from a plurality of heterogeneous renderers, such as a web renderer or a native extended-reality (XR) renderer. A mapping engine then translates the universal schema into renderer-specific primitives while preserving behavioral parity to ensure a consistent user experience across all devices. The system normalizes varied user inputs into a common event format to generate renderer-agnostic analytics, including spatial analytics such as gaze-based dwell time within 3D zones. This allows for unified measurement across all presentation modes from a single content source, eliminating the need for separate codebases and solving the problem of siloed analytics.

### RELATED APPLICATIONS

This application claims the benefit of, and priority to U.S. Provisional application, entitled “Systems and Methods for Immersive Web Content Creation,” filed on Sep. 30, 2024 and having application Ser. No. 63/701,519, the entirety of each of said application being incorporated herein by reference.

### FIELD

The present disclosure relates to immersive web content. More particularly, the present disclosure relates to a headless authoring and rendering platform for creating 2D, 3D, and blended 2D-to-3D experiences from a single, universal schema. The platform is configured to enable an “author-once, render-anywhere” workflow that ensures behavioral parity and unified analytics across heterogeneous devices and renderers.

### BACKGROUND

Implementing immersive web experiences comes with significant technical challenges, primarily due to the complexity of developing 3D elements that function seamlessly across various devices, including mobile, desktop, and VR headsets. Ensuring that these experiences are compatible and accessible across different platforms is difficult, as users may have a wide range of devices with varying capabilities. This often leads to inconsistent user experiences and may limit the reach of immersive web projects.

A primary consequence of these challenges is that organizations typically build and maintain separate, fragmented codebases for each runtime environment, such as one for a 2D website and a completely different one for a 3D or native XR application. This fragmentation causes significant problems. It leads to duplicated engineering and content operations, as every change must be rebuilt multiple times, which inflates costs and slows down iteration. This approach also results in inconsistent behavior and user experiences across 2D and 3D contexts, as interactions are implemented differently in each stack.

Furthermore, this separation of codebases leads to siloed analytics, where data from 2D web interactions and 3D telemetry are recorded in incompatible schemas. This prevents an accurate, apples-to-apples measurement of user engagement, dwell time, and conversion across different modalities, making it difficult to understand the complete user journey. What is missing is an architecture that bridges the 2D and 3D worlds from a single source of truth, allowing for seamless blending between them while enforcing behavioral parity and producing unified analytics.

### SUMMARY OF THE DISCLOSURE

Systems and methods for immersive web content in accordance with embodiments of the disclosure are described herein. In some embodiments, a device includes a processor, a memory communicatively coupled to the processor, and an immersive web logic stored in the memory and executable by the processor. The immersive web logic is configured to retrieve a runtime-agnostic universal schema, determine one or more capabilities of the device, select a renderer based on the one or more capabilities, translate the universal schema into one or more renderer-specific primitives for the selected renderer, normalize a plurality of input types received from the selected renderer into a common event format generate renderer-agnostic analytics data based on the common event format, and transmit the renderer-agnostic analytics data.

In some embodiments, the translation of the universal schema preserves behavioral parity across the plurality of heterogeneous renderers.

In some embodiments, the renderer is selected from a plurality of heterogeneous renderers.

In some embodiments, the plurality of heterogeneous renderers includes at least a web renderer and a native extended-reality (XR) renderer.

In some embodiments, the immersive web logic is further configured to determine if an extended-reality (XR) session is available as one of the one or more capabilities, and wherein the selected renderer is the native XR renderer in response to determining the XR session is available, and wherein the selected renderer is the web renderer in response to determining the XR session is unavailable.

In some embodiments, the runtime-agnostic universal schema is configured to define one or more assets.

In some embodiments, the one or more assets include at least a two-dimensional (2D) presentation, a three-dimensional (3D) presentation, and a blended 2D-to-3D presentation.

In some embodiments, a device, wherein the blended 2D-to-3D presentation, when rendered by an extended-reality (XR) renderer, includes one or more 3D assets rendered as a spatial environment and one or more 2D assets rendered as a view-anchored overlay.

In some embodiments, the renderer-agnostic analytics data is based on the universal schema.

In some embodiments, the renderer-agnostic analytics data includes a spatial analytic, and wherein generating the spatial analytic includes performing an intersection test between a spatial input type and a geometric zone defined in the universal schema.

In some embodiments, determining the one or more capabilities further includes computing a capability score based on at least one of a graphics feature, network quality, or a thermal state of the device, and wherein the renderer is selected based on the capability score.

In some embodiments, the plurality of input types includes at least one of a pointer event, a touch event, a gaze event, or a controller event.

In some embodiments, a method for providing cross-platform delivery of immersive content includes retrieving, via a client-side device, a runtime-agnostic universal schema from a server-side device, determining one or more capabilities of the client-side device, selecting a renderer based on the one or more capabilities, translating the universal schema into one or more renderer-specific primitives for the selected renderer, normalizing a plurality of input types associated with the client-side device, generating renderer-agnostic analytics data based on the normalized plurality of input types, and transmitting the renderer-agnostic analytics data to the server-side device.

In some embodiments, the plurality of input types are received from the selected renderer.

In some embodiments, the plurality of input types are normalized into a common event format.

In some embodiments, renderer-agnostic analytics data is based on the common event format.

In some embodiments, the renderer is selected from a plurality of heterogeneous renderers.

In some embodiments, translating the universal schema preserves behavioral parity across the plurality of heterogeneous renderers.

In some embodiments, the universal schema defines at least a two-dimensional (2D) presentation, a three-dimensional (3D) presentation, and a blended 2D-to-3D presentation.

In some embodiments, the blended 2D-to-3D presentation includes rendering one or more 3D assets as a spatial environment and rendering one or more 2D assets as a view-anchored overlay within an extended-reality (XR) session.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual block diagram of a device suitable for configuration with an immersive web logic, in accordance with various embodiments of the disclosure;

FIG. 2 is a diagram depicting various subsets of artificial intelligence in accordance with various embodiments of the disclosure;

FIG. 3 depicts different methods of machine-based learning in accordance with various embodiments of the disclosure;

FIG. 4 depicts a machine learning lifecycle in accordance with various embodiments of the disclosure; and

FIG. 5 is an exemplary neural network for use in a immersive web content system in accordance with various embodiments of the disclosure;

FIG. 6 is a system block diagram illustrating an author-once, render-anywhere platform, in accordance with various embodiments of the disclosure;

FIG. 7 is a conceptual diagram illustrating how a universal schema can be translated into different rendering modes, in accordance with various embodiments of the disclosure;

FIG. 8 is a flowchart depicting a high-level process for authoring and delivering immersive content, in accordance with various embodiments of the disclosure;

FIG. 9 is a flowchart depicting a process for authoring content and validating extensions, in accordance with various embodiments of the disclosure;

FIG. 10 is a flowchart depicting a process for client-side renderer selection and provisioning, in accordance with various embodiments of the disclosure;

FIG. 11 is a flowchart depicting a process for mapping a universal schema to a selected renderer, in accordance with various embodiments of the disclosure;

FIG. 12 is a flowchart depicting a process for handling normalized inputs and emitting analytics, in accordance with various embodiments of the disclosure; and

FIG. 13 is a flowchart depicting a process for runtime adaptation and applying fallbacks, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the problems outlined above, embodiments of the disclosure described herein can provide a headless authoring and rendering platform that enables an “author-once, render-anywhere” workflow. By leveraging a universal schema as a single source of truth, the platform delivers consistent 2D, 3D, and blended immersive experiences across a plurality of heterogeneous renderers. This architecture eliminates redundant engineering efforts, enforces behavioral parity between different user experiences, and produces unified, cross-platform analytics from a single content source.

A goal of the embodiments described herein is to solve the widespread problem of content fragmentation in digital experiences. Currently, organizations are often forced to build and maintain entirely separate codebases for their conventional two-dimensional (2D) web applications and their three-dimensional (3D) or extended-reality (XR) spatial applications. This fragmentation leads to significant inefficiencies, including duplicated engineering efforts, inflated costs, and slower content updates. Furthermore, it results in inconsistent user experiences and siloed analytics, making it impossible to measure user engagement in a unified way across different platforms.

To address these challenges, the application provides an overview of an “author-once, render-anywhere” platform that operates from a single source of truth. The system utilizes a runtime-agnostic universal schema that serves as a complete blueprint for an immersive experience. This schema is configured to define all assets, interactive panels, triggers, and actions required for a presentation, and it is capable of describing 2D layouts, 3D scenes, and blended 2D-to-3D compositions within a single structure. This single source of truth allows the system to eliminate the need for separate codebases for different platforms.

The overall system is designed to intelligently adapt this universal schema for any given end-user device. On a client device, a runtime selector first probes the device's own capabilities, such as its graphics features, network quality, or the availability of an XR session. Based on this assessment, it selects the most appropriate renderer from a plurality of heterogeneous options, such as a browser-based web renderer or a high-performance native XR renderer. A mapping engine then translates the universal schema into renderer-specific primitives, ensuring that behavioral parity is preserved so that user interactions remain consistent and predictable across all devices and rendering modes.

A goal of this architecture is to provide unified, cross-platform analytics that are impossible to achieve with separate codebases. The system normalizes all user inputs-whether from a mouse, touchscreen, or XR controller-into a common event format, allowing it to generate renderer-agnostic analytics data. This enables the consistent measurement of user engagement and spatial metrics, such as gaze-based dwell time, across both 2D and 3D modalities. Another goal is future-proofing, as the architecture allows for the support of future device classes simply by adding a new renderer adapter, without requiring any of the original content in the universal schema to be re-authored

Those skilled in the art will recognize that a universal schema means a runtime-agnostic representation of an entire immersive experience. This schema can be configured to contain all the necessary definitions for content, including asset descriptors, scene graph nodes, interactive panels, triggers, actions, and animations. In many embodiments, an aspect of the universal schema is its ability to support 2D layout surfaces, 3D scene nodes, and composite or blended states within a single, unified structure. By serving as the single source of truth, the universal schema enables an “author-once, render-anywhere” workflow, eliminating the need for separate codebases for different platforms.

Behavioral parity is often understood to mean the guarantee that triggers and actions, when applied to the same universal schema, will produce semantically equivalent outcomes across different renderers and presentation modes. For example, a “select” trigger defined in the schema should execute the same corresponding action whether the user clicks a mouse in a web renderer or presses a controller button in an XR renderer. In some embodiments, this guarantee extends across different modes, ensuring that an interaction with a panel in a 2D context behaves identically to an interaction with the same panel in a 3D context. This ensures a consistent, intuitive, and predictable user experience, regardless of the user's device or how they are viewing the content.

Those skilled in the art will recognize that heterogeneous renderers means a plurality of fundamentally different runtime engines, each capable of consuming the universal schema to produce a visual and interactive experience. The embodiments described herein support at least two types of renderers a browser-based web renderer that utilizes web graphics APIs and a native extended-reality (XR) renderer that uses native graphics APIs. The system is designed to select the most appropriate renderer from these available options based on the capabilities of the client device. This allows the platform to deliver an experience that is optimized for the specific context, from a widely accessible web experience on a mobile phone to a high-performance spatial experience on an XR headset.

A blended presentation is often understood to mean a specific rendering mode in which one or more 2D overlay panels are rendered in the foreground while a 3D scene renders in the background. In this mode, user focus can alternate between the 2D overlay and the 3D scene, and the user may be provided with controls to explicitly enter or exit the fully immersive 3D scene. In various embodiments, a mapping engine is configured to manage the technical complexities of this mode, such as maintaining z-ordering, correctly routing user inputs, and preserving state as the user transitions between the 2D and 3D contexts. This mode serves as a powerful bridge between traditional 2D interfaces and fully immersive 3D environments.

Those skilled in the art will recognize that the runtime selector means a component of the client-side logic that is configured to choose a renderer from the available heterogeneous options. Upon initialization, this component can be configured to probe the capabilities of the client device, evaluating factors such as GPU features, network status, memory, and the availability of an XR session. Based on this capability assessment and a set of predefined policy rules, the runtime selector then selects and provisions the most appropriate renderer for the given context. This automated selection process ensures that the user is provided with the most optimal experience their device can support.

The mapping engine is often understood to mean the client-side logic responsible for translating the runtime-agnostic universal schema into renderer-specific primitives. The engine's functions can include loading the schema, resolving which asset variants or levels-of-detail (LOD) to use, constructing a scene graph, and placing UI panels. In many embodiments, the mapping engine also performs the crucial tasks of normalizing all user inputs into a common format and binding triggers to actions. This ensures that behavioral parity is maintained across all renderers and device types.

Those skilled in the art will recognize that renderer-agnostic analytics means analytics data that is captured and serialized in a consistent, standardized format, regardless of the renderer or device it originates from. This consistency can be made possible by first processing all user interactions through a normalization pipeline that converts varied inputs like mouse clicks, screen touches, and controller actions into a common event format. This process generates a unified dataset that allows for true apples-to-apples measurement of user engagement across different modalities. The resulting data solves the long-standing problem of siloed analytics that typically exists in multi-platform content strategies.

Spatial analytics is often understood to mean a specific subset of renderer-agnostic analytics that captures metrics related to a user's interaction within a 3D or XR environment. Examples of such metrics can include gaze-based dwell time within geometric zones, hotspot enter and exit events, and controller ray interactions. In many embodiments, these metrics are computed on the client device by performing mathematical intersection tests, such as raycasting, between a user's spatial input type (like a gaze vector) and a geometric zone that is defined in the universal schema. This provides deep, actionable insights into how users behave within and interact with an immersive space.

Those skilled in the art will recognize that an extension module means a package of author-defined code that can be attached to the universal schema to add custom functionality or behaviors to an experience. These modules can be written against a renderer-agnostic interface, allowing the same custom logic to be applied broadly. For an extension module to run, a corresponding renderer-specific adapter must be present on the client device to translate the generic code for the selected renderer. To ensure security and stability, these modules are executed within a sandboxed environment that constrains their execution with permission-gated APIs.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

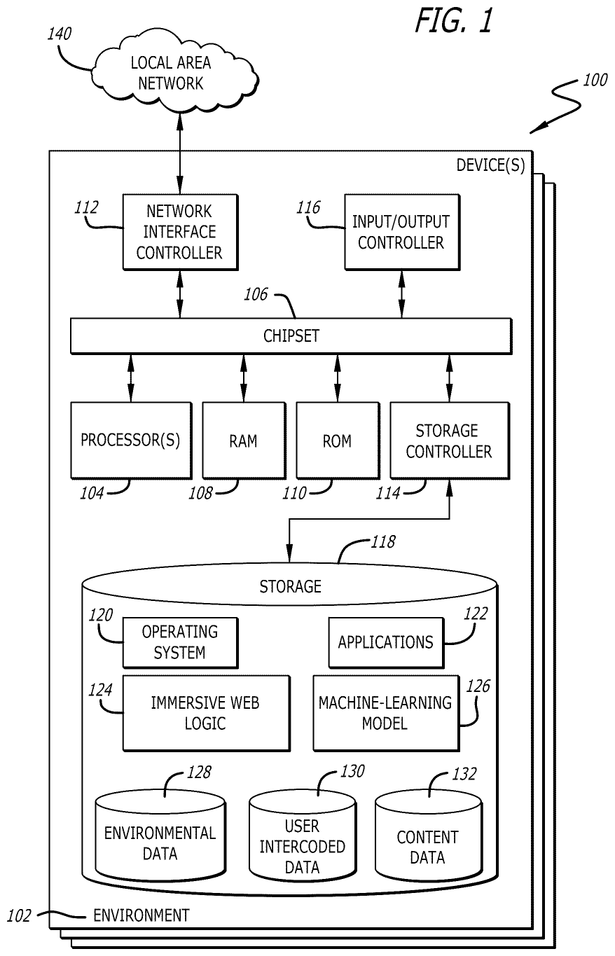

Referring to FIG. 1, a conceptual block diagram of a device 100 suitable for configuration with a immersive web logic 124, in accordance with various embodiments of the disclosure is shown. The embodiment of the conceptual block diagram depicted in FIG. 1 can illustrate a conventional augmented reality device, personal computer, mobile game device, game server, laptop, tablet, network appliance, e-reader, smartphone, wearable device, or other computing device, and can be utilized to execute any of the application and/or logic components presented herein. The device 100 may, in many non-limiting examples, correspond to physical devices or to virtual resources described herein.

In many embodiments, the device 100 may include an environment 102 such as a baseboard or “motherboard,” in physical embodiments that can be configured as a printed circuit board with a multitude of components or devices connected by way of a system bus or other electrical communication paths. Conceptually, in virtualized embodiments, the environment 102 may be a virtual environment that encompasses and executes the remaining components and resources of the device 100. In more embodiments, one or more processors 104, such as, but not limited to, central processing units (“CPUs”) can be configured to operate in conjunction with a chipset 106. The processor(s) 104 can be standard programmable CPUs that perform arithmetic and logical operations necessary for the operation of the device 100.

In a number of embodiments, the processor(s) 104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 106 may provide an interface between the processor(s) 104 and the remainder of the components and devices within the environment 102. The device 100 can incorporate different types of processors to enhance performance and efficiency across various tasks. A central processing unit (CPU) can handle primary processing tasks such as game logic, AI, and player inputs, while a graphics processing unit (GPU) can be specialized for rendering high-resolution graphics and visual effects. Digital signal processors (DSPs) may manage audio processing, delivering high-quality sound without burdening the CPU. In portable devices, systems on a chip (SoCs) can be configured to integrate the CPU, GPU, memory, and peripherals to balance performance and efficiency. In some embodiments, application-specific integrated circuits (ASICs) can optimize specific functions like cryptographic processing, while neural processing units (NPUs) accelerate AI and machine learning tasks. Some high-end devices may also include physics processing units (PPUs) to handle complex physics calculations, further enhancing the realism and responsiveness of the gaming experience. However, those skilled in the art will recognize that the device 100 can any variety or combination of processor(s) 104 as needed to satisfy the desired application.

The chipset 106 can provide an interface to a random-access memory (“RAM”) 108, which can be used as the main memory in the device 100 in some embodiments. The chipset 106 can further be configured to provide an interface to a computer-readable storage medium such as a read-only memory (“ROM”) 110 or non-volatile RAM (“NVRAM”) for storing basic routines that can help with various tasks such as, but not limited to, starting up the device 100 and/or transferring information between the various components and devices. The ROM 110 or NVRAM can also store other application components necessary for the operation of the device 100 in accordance with various embodiments described herein.

Additional embodiments of the device 100 can be configured to operate in a networked environment using logical connections to remote computing devices and computer systems through a network, such as the local area network 140. The chipset 106 can include functionality for providing network connectivity through a network interface controller (“NIC”) 112, which may comprise a gigabit Ethernet adapter or similar component. The NIC 112 can be capable of connecting the device 100 to other devices over the local area network 140. It is contemplated that multiple NICs 112 may be present in the device 100, connecting the device to other types of networks and remote systems, such as the Internet.

In further embodiments, the device 100 can be connected to a storage 118 that provides non-volatile storage for data accessible by the device 100. The storage 118 can, for instance, store an operating system 120, and/or applications 122. In various embodiments, the storage 118 can be connected to the environment 102 through a storage controller 114 connected to the chipset 106. In certain embodiments, the storage 118 can consist of one or more physical storage units. The storage controller 114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

In additional embodiments, the device 100 can store data within the storage 118 by transforming the physical state of the physical storage units to reflect the information being stored. The specific transformation of physical state can depend on various factors. Examples of such factors can include, but are not limited to, the technology used to implement the physical storage units, whether the storage 118 is characterized as primary or secondary storage, and the like.

In many more embodiments, the device 100 can store information within the storage 118 by issuing instructions through the storage controller 114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. In some embodiments, the device 100 can further read or access information from the storage 118 by detecting the physical states or characteristics of one or more particular locations within the physical storage units.

In addition to the storage 118 described above, certain embodiments of the device 100 may also have access to other computer-readable storage media to store and retrieve information, such as program modules, data structures, or other data. It should be appreciated by those skilled in the art that computer-readable storage media is any available media that provides for the non-transitory storage of data and that can be accessed by the device 100. In some examples, operations performed by a cloud computing network, and or any components included therein, may be supported by one or more devices similar to device 100. Stated otherwise, some or all of the operations performed by the cloud computing network, and or any components included therein, may be performed by one or more devices 100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 118 can store an operating system 120 utilized to control the operation of the device 100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 118 can store other system or application programs and data utilized by the device 100.

In many additional embodiments, the storage 118 or other computer-readable storage media is encoded with computer-executable instructions which, when loaded into the device 100, may transform it from a general-purpose computing system into a special-purpose computer capable of implementing the embodiments described herein. These computer-executable instructions may be stored as application and transform the device 100 by specifying how the processor(s) 104 can transition between states, as described above. In some embodiments, the device 100 has access to computer-readable storage media storing computer-executable instructions which, when executed by the device 100, perform the various processes described above with regard to FIGS. 1 and 3-13. In certain embodiments, the device 100 can also include computer-readable storage media having instructions stored thereupon for performing any of the other computer-implemented operations described herein.

In a number of embodiments, the storage 118 can store one or more applications 122. Such applications can include a rendering engine, which may function as a native renderer (such as the native/XR renderer 644) for the immersive web logic 124. A rendering engine can manage core tasks such as rendering graphics, processing inputs, handling physics calculations, and managing audio by leveraging the device's CPU, GPU, and other hardware components. It can abstract hardware complexities to ensure smooth and efficient real-time interaction in an immersive environment. Additionally, in various embodiments, the rendering engine can facilitate network communications for multi-user experiences and supports cross-platform functionality, allowing immersive content to run effectively on a variety of devices.

In many further embodiments, the device 100 may include an immersive web logic 124. The immersive web logic 124 can be configured to perform one or more of the various steps, processes, operations, and/or other methods that are described above. Often, the immersive web logic 124 can be a set of instructions stored within a non-volatile memory that, when executed by the processor(s)/controller(s) 104 can carry out these steps, etc. In some embodiments, the immersive web logic 124 may be a client application that resides on a network-connected device, such as, but not limited to, a server, switch, personal or mobile computing device in a single or distributed arrangement.

In some embodiments, environmental data 128 can refer to the information that captures the external factors and conditions surrounding a user's experience with an immersive web system, providing crucial insights that help tailor the experience to their specific situation. This data may include device-related details such as the type of device being used, screen resolution, available processing power, and battery status, as well as network conditions like bandwidth, latency, and connection stability. It can also encompass location-based information, such as the user's geographic location, time zone, and local weather or ambient lighting conditions, which can influence how content is presented. For instance, the system may adjust the level of visual detail or complexity based on the user's device capabilities, ensuring that even users with less powerful hardware still have a smooth and enjoyable experience. If the system detects a slower internet connection, it might opt to load lower-resolution assets or pre-buffer certain elements to maintain fluidity and minimize lag. In more advanced applications, environmental data might also factor in real-world context, such as whether the user is in a quiet environment, which could influence audio levels or the inclusion of certain sound effects. By leveraging environmental data, the system can dynamically adapt to each user's specific circumstances, providing an experience that feels seamless, responsive, and well-suited to their individual environment. This adaptability not only enhances user engagement but also ensures that the immersive experience remains accessible and enjoyable across a wide variety of settings, devices, and conditions.

In more embodiments, user interaction data 130 can consist of detailed information about how individuals engage with an immersive web experience, capturing a wide range of inputs and behaviors to provide insights into user preferences, habits, and engagement patterns. This data may include mouse movements, clicks, touch gestures on mobile devices, and more advanced inputs like hand gestures and gaze tracking when using VR headsets. For instance, in a VR environment, the system may track how a user's head and eyes move, where they focus their attention, and how they navigate through a 3D space. It may also record interactions such as how users manipulate objects, their response times, or the pathways they choose in an interactive environment. This rich dataset is invaluable for tailoring the experience to each user's needs and preferences, allowing the system to adjust content in real-time.

For example, if the data indicates that users often look at a specific element or struggle with a particular interaction, the system can adapt by highlighting that element more prominently or simplifying the interaction to enhance usability. Over time, this data helps in refining the overall design, ensuring the experience becomes more intuitive and engaging, which can ultimately lead to increased user satisfaction and retention. It can also enable personalized experiences by learning user preferences, such as adjusting the difficulty of a task, suggesting relevant content, or even providing guidance based on previous actions, making the immersive experience feel more responsive and tailored to individual behaviors.

In further embodiments, content data 132 can encompass all the digital assets and information required to build and present an immersive web experience, including 3D models, animations, images, audio files, textures, and video elements. It may also involve metadata that describes these assets, such as file formats, resolutions, compression levels, and performance requirements. This data is crucial because it determines the visual and auditory elements that users interact with, as well as how these elements are rendered and displayed across different devices. For example, a system might have multiple versions of a 3D model with varying levels of detail to ensure smooth performance on devices with different processing capabilities. The content data 132 can enable the system to intelligently choose the appropriate version of an asset based on the user's hardware, ensuring that the experience remains visually impressive while optimizing performance.

Additionally, this data may allow for dynamic adjustments, such as loading lower-resolution textures for users on slower networks to reduce loading times or providing more detailed and complex visuals for those with high-performance devices. Content data may also be used to customize experiences based on user preferences or interaction history, ensuring that the elements presented are relevant and engaging. For instance, the system might prioritize certain animations or visual themes that align with a user's past interactions, thereby creating a more personalized and captivating experience. This dynamic use of content data ensures that the immersive web experience is consistently responsive, adaptable, and capable of delivering high-quality visuals and audio tailored to the unique needs of each user.

In still further embodiments, the device 100 can also include one or more input/output controllers 116 for receiving and processing input from a number of input devices, such as a keyboard, a mouse, a touchpad, a touch screen, an electronic stylus, or other type of input device. Similarly, an input/output controller 116 can be configured to provide output to a display, such as a computer monitor, a flat panel display, a digital projector, a printer, or other type of output device. Those skilled in the art will recognize that the device 100 might not include all of the components shown in FIG. 1 and can include other components that are not explicitly shown in FIG. 1 or might utilize an architecture completely different than that shown in FIG. 1.

As described above, the device 100 may support a virtualization layer, such as one or more virtual resources executing on the device 100. In some examples, the virtualization layer may be supported by a hypervisor that provides one or more virtual machines running on the device 100 to perform functions described herein. The virtualization layer may generally support a virtual resource that performs at least a portion of the techniques described herein.

Finally, in numerous additional embodiments, data may be processed into a format usable by one or more machine-learning models 126 (e.g., feature vectors), and or other pre-processing techniques. The machine-learning (“ML”) models 126 may be any type of ML model, such as supervised models, reinforcement models, and/or unsupervised models. The ML models 126 may include one or more of linear regression models, logistic regression models, decision trees, Naïve Bayes models, neural networks, k-means cluster models, random forest models, and/or other types of ML models 126.

The ML model(s) 126 can be configured to generate inferences to make predictions or draw conclusions from data. An inference can be considered the output of a process of applying a model to new data. This can occur by learning from at least the environmental data 128, user interaction data 130, and content data 132. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a set of coordinates within a three-dimensional space, a probability distribution, a set of labels/characteristics/parameters, a decision about an action to take, etc. Ground truth for the ML model(s) 126 may be generated by human/administrator verifications or may compare predicted outcomes with actual outcomes.

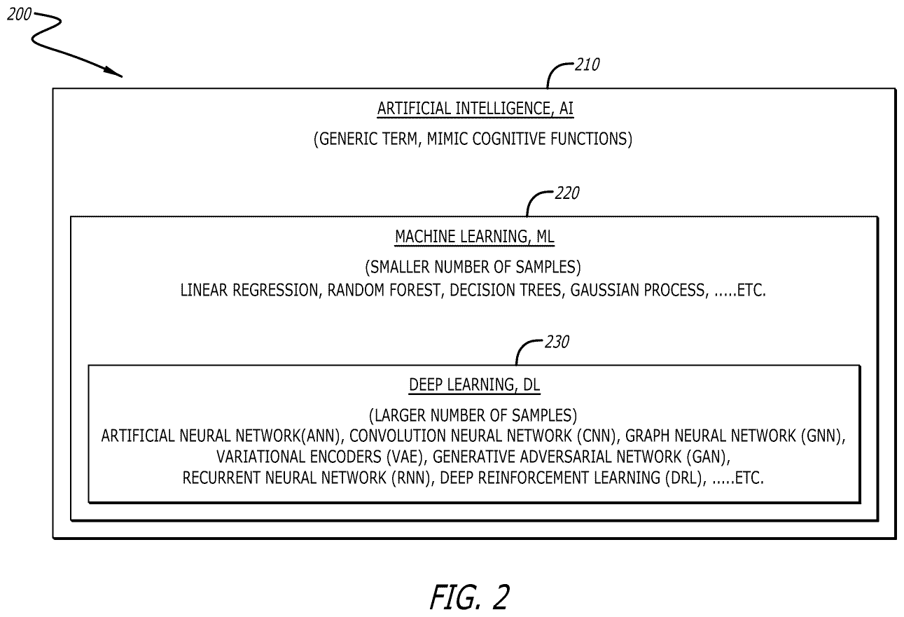

Although a specific embodiment for a device 100 suitable for configuration with an immersive web logic 124 is discussed with respect to FIG. 1, any of a variety of systems and/or processes may be utilized in accordance with embodiments of the disclosure. For example, the device 100 could be a dedicated, standalone extended-reality (XR) headset, or it could be a thin-client device that streams the immersive experience from a remote server. The elements depicted in FIG. 1 may also be interchangeable with other elements of FIGS. 2-13 as required to realize a particularly desired embodiment.

Referring to FIG. 2, a diagram 200 depicting various subsets of artificial intelligence in accordance with various embodiments of the disclosure is shown. Artificial intelligence (AI 210) is typically understood in the art to be the development of machines and algorithms that mimic human intelligence, for example, by optimizing actions to achieve certain goals. At its core, AI 210 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 210 can be considered a generic term because it encompasses a wide range of subfields and techniques, from simple rule-based systems to advanced machine learning and deep learning models. These AI techniques are used to simulate various aspects of human cognition. For example, machine learning (ML 220) allows computers to learn from data patterns without explicit programming for each task, while natural language processing (NLP) enables machines to understand and generate human language. Deep learning (DL 230), a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 210 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML 220) is a subset of Artificial Intelligence (AI 210) that focuses on the development of algorithms and statistical models that enable computers to learn and make decisions from data without explicit programming. In traditional programming, a computer is given a fixed set of rules to follow, but ML 220 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to tailor personalized content, generate predictive analytics for renderer selection, or adapt contextual content for an immersive web experience.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 220. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from content data, user interaction data, environmental data, and behavioral feedback, among other sources.

However, traditional ML methods rely heavily on feature engineering, wherein human experts manually identify the most relevant features or patterns within the data. For example, when using ML 220 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than 100) to learn effectively.

Deep Learning (DL) 230 is a specialized subset of Machine Learning (ML) 220 that employs multi-layered artificial neural networks to automatically learn complex patterns and representations from large, often unstructured datasets. Inspired by the way the human brain processes information, DL 230 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 230 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML 220 neural network designed to work particularly well with image data, making them highly relevant for as image and 3D model data are core components of an immersive web experience and thus can be subject to processing. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction, such as classifying an asset type or generating a capability score suitable for selecting a renderer.

While CNNs are well-suited for grid-based data like images, many real-world problems in can involve non-grid data, such as user device capabilities, data privacy rules, or user interaction patterns. This type of data may better be represented as a graph, where nodes represent entities (e.g., immersive content locations) and edges represent relationships between them (e.g., user preference values). Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is crucial in predicting properties that depend on the current/local structure, such as the behavior of an immersive web content or the properties of a user consuming that content.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to generate variations of an immersive web experience or the like.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. This type of process may be utilized to compare generated user interaction patterns to an actual user's behavior.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex immersive web experience generation simulations.

In immersive content delivery systems, DRL can be used in scenarios where an optimal decision needs to be made, such as optimizing which renderer to select or finding the best configuration for an asset variant to display based on the desired or current properties of the user(s) and their device(s). The combination of RL and DL can allow for learning from raw data, making it a powerful tool for dynamic and real-time decision-making within an immersive content delivery system.

Although a specific embodiment for a diagram 200 depicting various subsets of artificial intelligence suitable for carrying out the various steps, processes, methods, and operations described herein is discussed with respect to FIG. 2, any of a variety of systems and/or processes may be utilized in accordance with embodiments of the disclosure. For example, other subset may be present and available for use within AI 210. Those skilled in the art will recognize that the diagram 200 presented in FIG. 2 is simplified for illustration purposes and various methods and techniques may interact with other areas (ML 220 with DL 230, etc.). The elements depicted in FIG. 2 may also be interchangeable with other elements of FIGS. 1 and 3-13 as required to realize a particularly desired embodiment.

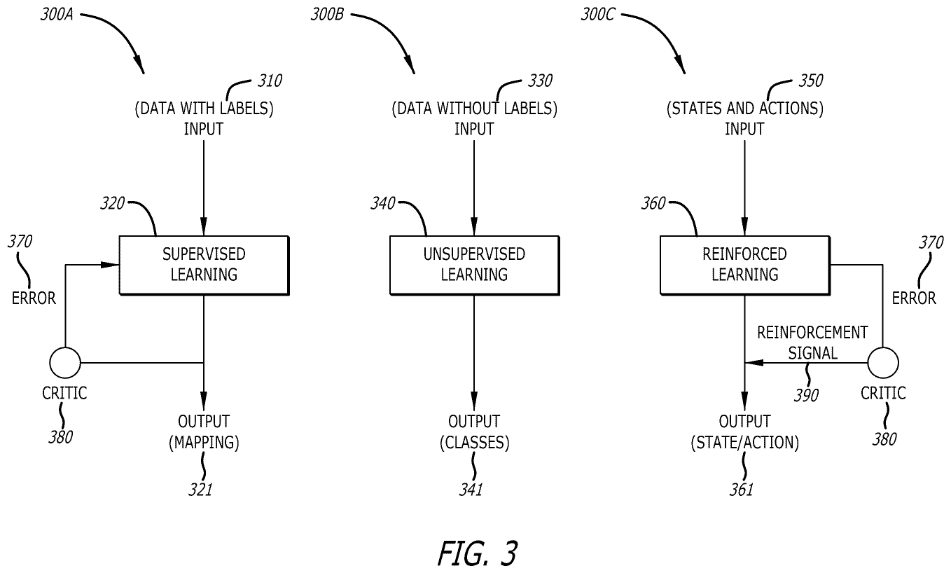

Referring to FIG. 3, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 3, a supervised learning system 300A is shown. The supervised learning system 300A can be configured with a supervised learning model 320 that accepts input data 310 and generates an output 321. However, the output data is often reviewed by a critic 380 that can determine one or more errors 370 that are fed back into the supervised learning model 320 for use in updating.

Supervised learning systems 300A are often considered the simplest machine learning model to understand in which input data (such as training data) has a known label or result as an output. So, the supervised learning model 320 can be understood to work on the principle of input-output pairs. As such, a function can be trained using a training data set, which is then applied to unknown data and makes some predictive performance. Supervised learning is task-based and mostly tested on labeled data sets.

Supervised learning systems 300A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to various immersive web content display options and the resulting user engagement. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are the another type of supervised learning, which can be used to generate conclusions from observed values in one or more categorical forms. For example, a classification model can identify if an email is spam or not; whether a device is suitable for a native XR renderer or a web renderer, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P (y|X) of that class given a particular predictor. P (y) is the prior probability of that class, P (X) is the prior probability of the predictor, and P (X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features. Likewise, various embodiments herein can classify based on device type, network bandwidth, and user preferences, etc.

Again, in the embodiment depicted in FIG. 3, an unsupervised learning system 300B is shown. The unsupervised learning system 300B can be configured with an unsupervised learning model 340 that accepts input data 330 and generates an output 341. Unlike other model types, there are no critics or error signals to process. Unsupervised learning models 340 can implement the learning process opposite to supervised learning, which means it enables the model to learn from an unlabeled training dataset. Based on the unlabeled dataset, the unsupervised learning model 340 can predict the output. Using an unsupervised learning system 300B, the unsupervised learning model 340 can learn hidden patterns from the dataset by itself without any supervision. In various embodiments, unsupervised learning models 340 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to generate an immersive web experience with a maximized overall user satisfaction or interaction score. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 3, a reinforcement learning system 300C is shown. The reinforcement learning system 300C can be configured with a reinforcement learning model 360 that accepts input data 350 and generates an output 361. In reinforcement learning, the reinforcement learning model 360 learns actions for a given set of states that lead to a goal state. In the embodiment depicted in FIG. 3, a critic 380 can receive or otherwise notice an error 370 within the reinforcement learning model 360 actions, and adjust the outcome/output such that the “reward” or “punishment” is adjusted to better model the future behaviors or processing of the reinforcement learning model 360.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 3, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 3 may also be interchangeable with other elements of FIGS. 1-2 and 4-13 as required to realize a particularly desired embodiment.

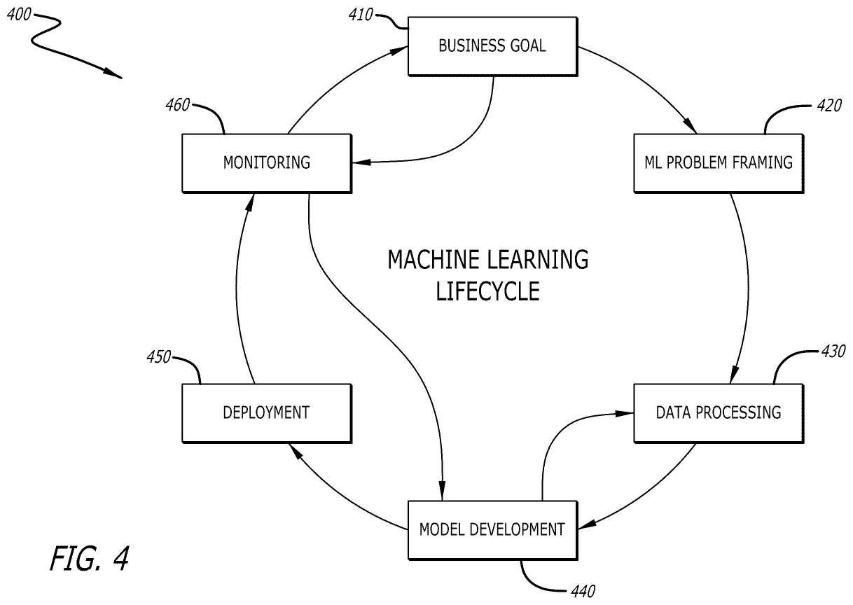

Referring to FIG. 4, a machine learning lifecycle 400 in accordance with various embodiments of the disclosure is shown. During the development of machine learning systems, the embodiment depicted in FIG. 4 can provide a framework for how to structure the design and maintenance of these systems. This machine learning lifecycle 400 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 400 emphasizes that developing a machine learning model is not a one-time effort but an iterative process requiring ongoing monitoring and adjustment. The feedback loop inherent in the machine learning lifecycle 400 allows for continual refinement and optimization of models to maintain their accuracy and relevance.

In many embodiments, a first stage of the machine learning lifecycle 400 is identifying the business goal 410, which sets the overall direction and purpose of the ML project. This can involve understanding the specific problems or opportunities within the business or project that machine learning can address. A clear business goal 410 ensures that the project remains focused on delivering tangible value, whether it is improving user experiences, optimizing renderer selection, predicting user preferences, or ensuring behavioral parity across devices. Without a well-defined goal, it can be challenging to align the subsequent stages of the ML lifecycle 400, as the choice of model, data processing methods, and performance metrics can all depend on what the business aims to achieve.

Establishing a proper business goal 410 can also involve engaging with key stakeholders and developers to gather requirements and set success criteria. It can provide a roadmap that outlines what success looks like and helps in framing the ML problem. For example, if the goal is to optimize performance on low-end devices, the project might focus on a predictive model that selects a lower-fidelity asset variant or a less resource-intensive renderer, allowing the immersive web system to adapt proactively. Clearly defined goals not only help guide the project but also provide benchmarks for evaluating the effectiveness of the deployed model once it enters production.

Once the business goal 410 is established, various embodiments take a next step involving ML problem framing 420, wherein the goal is translated into a specific machine learning task. This can involve selecting the appropriate type of ML problem, such as classification, regression, clustering, or recommendation, and defining the target variables or outputs. For example, if the goal is to select the most appropriate renderer, the problem can be framed as a multi-class classification task where the model predicts whether to use a web renderer, a native XR renderer, or a low-fidelity fallback based on device capabilities. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 430 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 430 can require or at least benefit from careful planning and iterative refinement. Once the data is processed, it is typically split into training, validation, and test sets to develop and evaluate the model, ensuring that it generalizes well to new, unseen data.

Model development 440 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 440, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 430.

In further embodiments, deployment 450 is the stage where the developed model is integrated into the production environment to perform its intended tasks. This phase may involve setting up the necessary infrastructure, such as APIs or cloud-based services, to allow the model(s) to process live data and generate predictions. Deployment 450 can transform the model from a research tool into a functional component of a business process or product, providing real-time insights, automations, or decisions.

Proper deployment 450 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 410.

In more embodiments, monitoring 460 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 460, teams can identify when the model's performance drops and requires retraining or adjustments to align with the evolving data.

Monitoring 460 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 430 and model development 440, to refine the model(s) as needed. This iterative process allows the machine learning system to adapt and maintain its alignment with the original business goal 410 over time.

Although a specific embodiment for a machine learning lifecycle 400 suitable for carrying out the various steps, processes, methods, and operations described herein is discussed with respect to FIG. 4, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 4 may also be interchangeable with other elements of FIGS. 1-3 and 5-13 as required to realize a particularly desired embodiment.

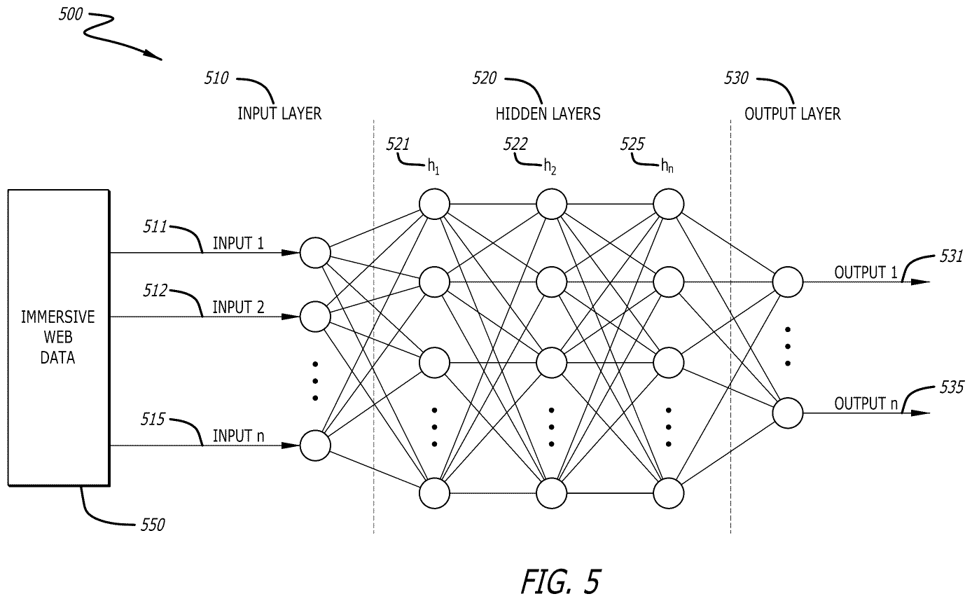

Referring to FIG. 5, an exemplary neural network 500 in accordance with various embodiments of the disclosure is shown. The embodiment depicted specifically depicts a feedforward neural network with multiple layers. This type of network consists of an input layer 510, one or more hidden layers 520, and an output layer 530. Each layer contains nodes (or neurons) that are interconnected, representing how data flows through the network. The input layer 510 can receive raw data, which is then processed by the hidden layers 520 through weighted connections and activation functions. These hidden layers 520 can enable the network to learn complex patterns and relationships within the data.

The final output layer 530 produces the network's predictions or classifications based on the processed input. The interconnected nature of the nodes allows the neural network 500 to learn from data during training by adjusting the weights of connections to minimize prediction errors. This structure is the foundation of deep learning models, as adding more hidden layers 520 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 500 depicted in the embodiment of FIG. 5, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 5 is presented as an exemplary ML solution that may be deployed within one or more methods or systems described herein.

In many embodiments, the input layer 510 is the first layer in a neural network 500 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 500 are generally scaled i.e., normalized to have a zero mean and/or unit standard deviation. Scaling can also be applied to the input of hidden layers (using batch or layer normalization) to improve the stability of neural network 500.

Unlike the hidden layers 520 and output layers 530, the input layer 510 typically does not perform any computations or transformations on the data. Its primary function is often to pass the input data to the next layer in the network, the first hidden layer 521. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 510 itself does not modify the data, it sets the stage for the neural network to extract complex patterns and relationships through the deeper layers. This flexibility in handling various types of input make the neural network 500 a powerful tool for a diverse set of applications.

With respect to the embodiments described herein, the input layer may be configured with a plurality of inputs providing immersive web data 550, or other data sources. For example, a model can be configured with a first input 511 representing a device's GPU capabilities, and a second input 512 representing current network bandwidth, while additional inputs can be added related to other device features. The nth input 515 can be configured in certain embodiments to include a flag indicating whether an extended-reality (XR) session is available. As those skilled in the art will recognize, additional setups can be configured such that the inputs can include different device parameters, environmental data, or even user interaction history to inform a prediction.

In a number of embodiments, the neural network 500 comprises a plurality of hidden layers 520. The embodiment depicted in FIG. 5 comprises a first hidden layer 521, a second hidden layer 522, and an nth hidden layer 525, which are denoted as h1, h2, and hn respectively. In many embodiments, the hidden layers 520 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 521 h1 receives direct input from the input layer, transforming the raw data into an initial set of features. For example, in an image recognition task, this layer might begin identifying basic patterns, such as edges or simple textures. The output of the first hidden layer 521 is then passed to a second hidden layer 522 h2, which builds upon the features identified by the first hidden layer 521. This deeper layer might start recognizing more complex patterns, such as shapes or specific object components, by combining the lower-level features identified earlier. This can continue on until a last, nth hidden layer 525 hn continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first input layer 521 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 530 is often the final layer in a neural network and is responsible for producing the network's predictions or classifications based on the information processed through the previous hidden layers 520. Each neuron in the output layer 530 can represent a specific outcome or category that the model can predict. In the embodiment depicted in FIG. 5, the outputs are labeled as “output 1” to “output n,” indicating that the network can be designed to have a varying number of outputs depending on the nature of the problem being solved for. For example, in a binary classification task (e.g., selecting a web renderer vs. a native renderer), there would typically be a single output neuron that provides a probability score for one of the two classes/outcomes. In contrast, for multi-class classification (e.g., categorizing the best suited renderer from a plurality of heterogeneous renderers), the output layer would contain multiple neurons, each corresponding to a different class.

The number of neurons in the output layer 530 can also designed specifically for other types of tasks, such as regression, where the model can predict continuous values. In such cases, the output layer 530 might contain a single neuron representing a numerical prediction, such as the price of a house or the temperature forecast, etc. Alternatively, in complex applications like multi-label classification (where each input can belong to multiple classes simultaneously), the output layer 530 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a softmax function can be applied to output a set of probabilities that sum to 1, indicating the most likely class. For regression problems, a linear activation function is often used to output a continuous range of values. The flexibility in designing the output layer allows the neural network 500 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 5, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 5, which is an illustrative example meant to make it easier to explain the basic concepts of neural networks and how they process information. The specific features and functions described herein are not intended to be limiting to this specific embodiment. Additionally, the elements depicted in FIG. 5 may also be interchangeable with other elements of FIGS. 1-4 and 6-13 as required to realize a particularly desired embodiment.

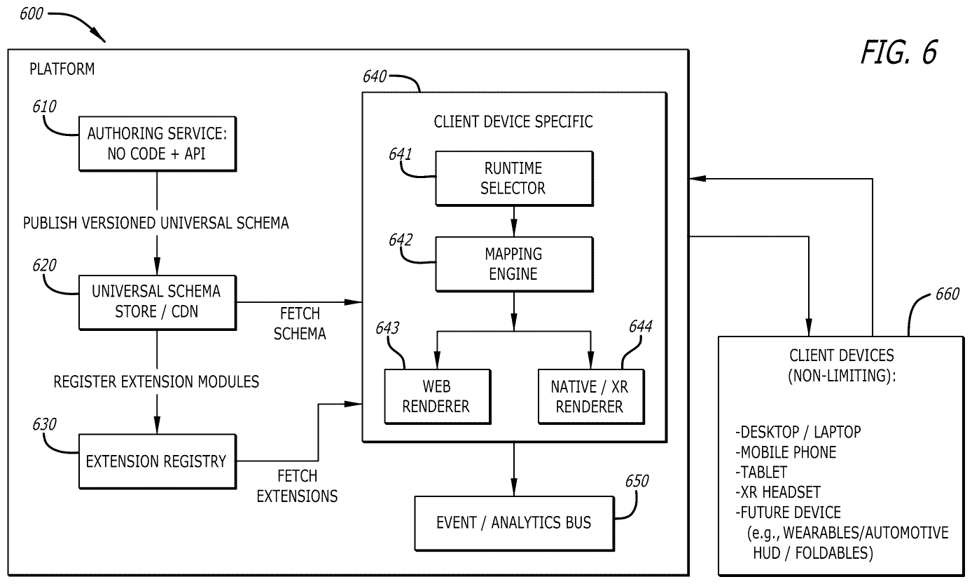

Referring to FIG. 6, a system block diagram of an author-once, render-anywhere platform 600, in accordance with various embodiments of the disclosure is shown. In many embodiments, the platform 600 can represent the end-to-end system architecture for creating and delivering immersive content. The platform 600 may be conceptually divided into a server-side environment and a client-side environment. In some embodiments, the server-side components can be responsible for the creation, storage, and distribution of content and optional extensions. The client-side components, conversely, can be responsible for retrieving, processing, and rendering the immersive experience on an end-user device.

In various embodiments, an authoring service 610 may be configured as a tool for generating content that is persisted as a runtime-agnostic universal schema. This service can provide a no-code user interface, allowing authors and designers to visually compose 2D, 3D, and blended experiences by defining assets, panels, and triggers. In certain embodiments, the authoring service 610 can also expose an Application Programming Interface (API). This allows for programmatic content generation, enabling developers to automate the creation of schemas from external data sources or integrate the authoring pipeline into other workflows.

In a number of embodiments, a universal schema store/CDN 620 can act as the central distribution endpoint for the content. This component may be configured to host the versioned universal schemas that are published from the authoring service 610. In more embodiments, this store can be implemented on a Content Delivery Network (CDN) to ensure fast and reliable delivery of the schema and its associated assets to client devices across the globe. The universal schema store/CDN 620 can function as the single source of truth that client devices retrieve content from.

In further embodiments, an extension registry 630 can be provided to manage optional code overrides. This registry may serve as a repository for extension modules that authors can reference from the universal schema to add custom functionality or behaviors to an experience. Each module in the extension registry 630 can be registered against a renderer-agnostic interface, with corresponding renderer-specific adapters that ensure the custom code can run safely and consistently across different platforms. This component enables the platform to be extensible while maintaining governance and security.

In additional embodiments, the client device specific logic 640 can represent the collection of components that execute on an end-user's device. This logic may be responsible for the entire client-side lifecycle of an immersive experience, from retrieving the content to rendering it and capturing analytics. In some embodiments, the client device specific logic 640 can comprise a runtime selector 641, a mapping engine 642, one or more renderers 643 and 644, and an event/analytics bus 650. These components can work together to provide an optimized and consistent experience tailored to the specific device.

In certain embodiments, a runtime selector 641 can be configured to determine which renderer is best suited for the client device. The runtime selector 641 may probe various capabilities of the device, such as its GPU features, memory, network status, and availability of an XR session. Based on this assessment and any applicable policy rules, it can select the most appropriate renderer to instantiate. For instance, this allows the platform to automatically choose a high-performance native renderer on an XR headset while selecting a more accessible web renderer on a mobile phone.

In various embodiments, a mapping engine 642 can be responsible for translating the retrieved universal schema into a format the selected renderer can understand. This engine may parse the runtime-agnostic definitions in the schema and convert them into renderer-specific primitives, scene graphs, and event bindings. In many embodiments, the mapping engine 642 can also normalize all user inputs into a common format. This ensures that the experience behaves consistently and predictably, thereby preserving behavioral parity regardless of the device or renderer being used.

In some embodiments, a web renderer 643 can be one of the heterogeneous renderers available for selection. This renderer may be browser-based and utilize standard web technologies such as WebGL or WebXR to render content. The web renderer 643 can provide maximum accessibility, allowing experiences to be delivered via a simple URL without requiring a user to install a separate application. In a number of embodiments, this renderer may be the default choice on devices like desktops, laptops, and mobile phones.

In more embodiments, a native/XR renderer 644 can be another of the heterogeneous renderers available for selection. This renderer may be a standalone application or based on a game engine, designed for high-performance graphics and deep integration with a device's operating system. The native/XR renderer 644 can be the preferred choice on dedicated virtual or augmented reality hardware, such as an XR headset. This allows the platform to take full advantage of the specialized hardware to deliver highly immersive spatial experiences.

In still more embodiments, an event/analytics bus 650 may be configured to handle the collection and transmission of analytics data. This component can receive all interaction events that are generated as a user engages with the immersive experience. In many embodiments, it can be responsible for queuing, batching, and forwarding this renderer-agnostic analytics data to a backend analytics service. The event/analytics bus 650 ensures that all captured data is structured consistently, enabling unified measurement across all platforms.

In yet further embodiments, the client devices 660 can represent the wide and varied spectrum of end-user hardware that the platform 600 is configured to support. This can include, but is not limited to, desktops and laptops, mobile phones, tablets, and dedicated XR headsets. In additional embodiments, the platform architecture is designed to be future-proof, supporting future device categories such as wearables, automotive head-up displays (HUDs), or foldable devices. This forward compatibility can be achieved by creating new renderer adapters for new device classes without needing to re-author any of the original content.

Although a specific embodiment for a platform 600 is discussed with respect to FIG. 6, any of a variety of systems and/or devices may be utilized in accordance with embodiments of the disclosure. For example, the authoring service 610 and universal schema store/CDN 620 could be combined into a single, monolithic service or could be further distributed across multiple microservices. The elements depicted in FIG. 6 may also be interchangeable with other elements of FIGS. 1-5 and 7-13 as required to realize a particularly desired embodiment.

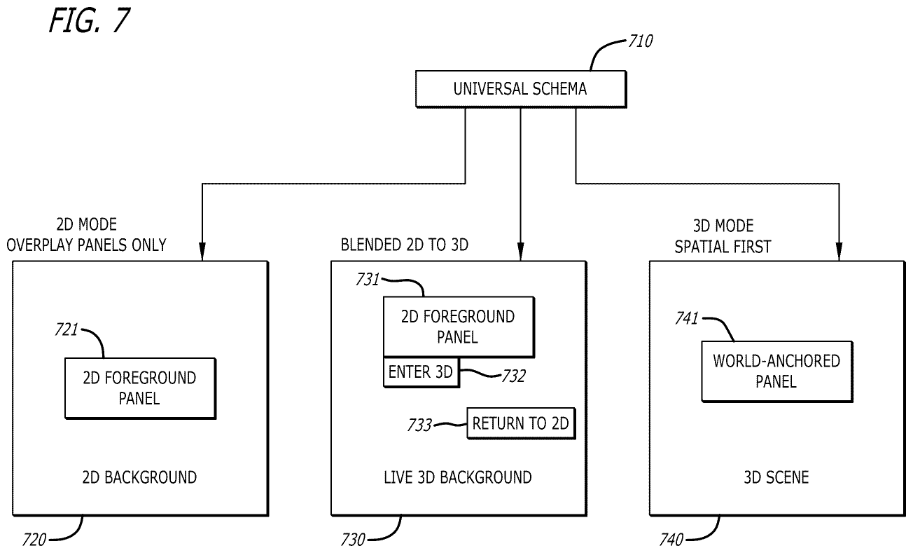

Referring to FIG. 7, a conceptual diagram illustrating how a universal schema can be translated into different rendering modes, in accordance with various embodiments of the disclosure is shown. In many embodiments, the universal schema 710 can serve as the single, runtime-agnostic source of truth for an entire immersive experience. This schema can contain the definitions for all content, including assets, panels, triggers, and actions, without being tied to a specific rendering engine or platform. In some embodiments, the universal schema 710 can be structured to define both two-dimensional (2D) layout surfaces and three-dimensional (3D) scene nodes concurrently. This allows a single authored file to be flexibly interpreted and rendered by a mapping engine into multiple distinct presentation modes.

In various embodiments, the universal schema 710 can be rendered in a 2D mode 720, which may be designated for overlay panels only. This mode can be utilized for experiences that are presented as traditional webpages or mobile applications, where the user interacts with the content entirely within a 2D plane. In certain embodiments, if the universal schema 710 contains 3D assets, they may be represented in this mode as 2D images, thumbnails, or simplified interactive viewers within the 2D background. This mode can ensure that content remains accessible on devices that do not support or require a fully immersive experience.

In a number of embodiments, the content within the 2D mode 720 can be presented in one or more 2D foreground panels 721. A 2D foreground panel 721 can be configured as a view-anchored overlay that contains user interface elements, text, and other media. In further embodiments, users may interact with this panel using standard inputs such as clicks, scrolls, or touch gestures. The triggers and actions associated with the elements in this panel can be defined in the universal schema 710 such that their behavior is preserved if the same panel is rendered in a different mode.

In more embodiments, the universal schema 710 can be rendered in a blended 2D to 3D mode 730. This mode can provide a hybrid experience where interactive 2D UI elements are presented in the foreground while a live 3D scene is visible in the background. In additional embodiments, this mode can serve as a bridge, allowing users to seamlessly transition between a 2D, information-rich context and a 3D, spatially immersive context. This approach can improve user engagement by showing a preview of the 3D world while still providing familiar 2D controls.

In still more embodiments, the blended 2D to 3D mode 730 can include a 2D foreground panel 731. Similar to the panel in the 2D mode, this panel can contain interactive controls and information, and the user may interact with it while the live 3D background continues to render. In certain embodiments, the 3D background may have a subtle motion, such as a slow orbit, to indicate that it is a live environment. The user can choose to remain in the 2D context or transition into the 3D scene.

In yet further embodiments, the 2D foreground panel 731 can contain triggers such as an enter 3D trigger 732 and a return to 2D trigger 733. The enter 3D trigger 732 can be configured to hand over primary control to the 3D scene, allowing the user to navigate and interact within the spatial environment. Conversely, the return to 2D trigger 733 can restore the 2D foreground panel 731 as the primary context. In some embodiments, the system can be configured to preserve the state across these transitions, so that the user's context is not lost when moving between 2D and 3D.

In additional embodiments, the universal schema 710 can be rendered in a 3D mode 740, which may be a spatial-first experience. This mode can be selected for devices that are fully immersive by default, such as an extended-reality (XR) headset, or when a user chooses to enter the 3D scene from a blended mode. In this mode, the user can be placed directly within the 3D scene and navigate it as their primary environment. In some embodiments, 2D UI elements may still be present in this mode as head-up display (HUD) overlays.

In many embodiments, the 3D mode 740 can contain one or more panels, such as a world-anchored panel 741. Unlike a view-anchored panel that remains fixed to the user's screen or viewpoint, a world-anchored panel 741 can be placed at a specific coordinate within the 3D scene itself. In certain embodiments, this allows the UI element to appear as a natural part of the environment, and the user may have to physically move or turn toward it to interact with it. This type of panel can be used for in-world signage, interactive terminals, or contextual information displays.

Although a specific embodiment for translating a universal schema is discussed with respect to FIG. 7, any of a variety of systems and/or processes may be utilized in accordance with embodiments of the disclosure. For example, an additional “audio-only” mode could be defined, where the universal schema is translated by an audio renderer to produce a non-visual, narrative experience for accessibility purposes. The elements depicted in FIG. 7 may also be interchangeable with other elements of FIGS. 1-6 and 8-13 as required to realize a particularly desired embodiment.

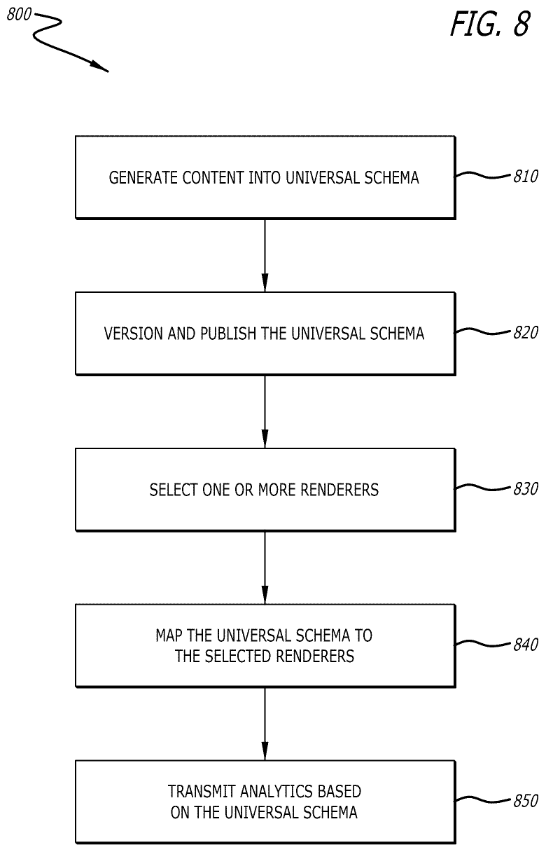

Referring to FIG. 8, a flowchart depicting a high-level process 800 for authoring and delivering immersive content, in accordance with various embodiments of the disclosure is shown. In many embodiments, the process 800 can generate content into a universal schema (block 810). For example, authors can create immersive experiences using a no-code studio environment to define assets, interactive panels, and trigger-based behaviors. This authoring process can emit a universal schema that abstracts runtime-specific details, allowing a single source of truth to support both 2D and 3D presentations. It is contemplated that, in some embodiments, the universal schema can also be generated programmatically via an Application Programming Interface (API), enabling automated content creation from external data sources.

In a number of embodiments, the process 800 can version and publish the universal schema (block 820). The finalized schema can be assigned a unique version identifier and uploaded to a distribution endpoint, such as a universal store or a Content Delivery Network (CDN), where it can be retrieved by client devices. In some embodiments, the versioning can be configured to support governance operations, such as tracking content updates over time or enabling a rapid rollback to a previous, stable version if an issue is discovered after publishing.

In more embodiments, the process 800 can select one or more renderers (block 830). This selection can be performed by a client device after it evaluates its own capabilities, such as its GPU features, network conditions, or the availability of an extended-reality (XR) session. For instance, a high-end device with an active XR session may select a native XR engine, whereas a mobile device on a slow network may select a more lightweight, browser-based web renderer. In other embodiments, the selection may be guided by a predefined policy, such as a “URL-first” policy that prioritizes the web renderer to maximize accessibility.

In further embodiments, the process 800 can map the universal schema to the selected renderers (block 840). A mapping engine can be configured to translate the runtime-agnostic definitions within the schema into renderer-specific primitives that the selected renderer can process and display. It is contemplated that the mapping engine can also be configured to preserve behavioral parity, ensuring that all trigger-action logic and user interactions produce a consistent and predictable user experience, regardless of which renderer is being used.

In additional embodiments, the process 800 can transmit analytics based on the universal schema (block 850). Renderer-agnostic analytics, including spatial metrics such as user dwell time within a 3D zone, can be captured and serialized into a standardized format. For example, a user interaction is recorded in the same data format whether it originates from a mouse click in a web renderer or a controller input in an XR renderer. These unified insights can then be transmitted to a backend analytics service for aggregation and measurement across all 2D and 3D experiences.

Although a specific embodiment for a process 800 for authoring and delivering immersive content is discussed with respect to FIG. 8, any of a variety of systems and/or processes may be utilized in accordance with embodiments of the disclosure. For example, the selection of a renderer could be performed on a server which then streams the rendered content to the client device, rather than the client performing the selection locally. The elements depicted in FIG. 8 may also be interchangeable with other elements of FIGS. 1-7 and 9-13 as required to realize a particularly desired embodiment.

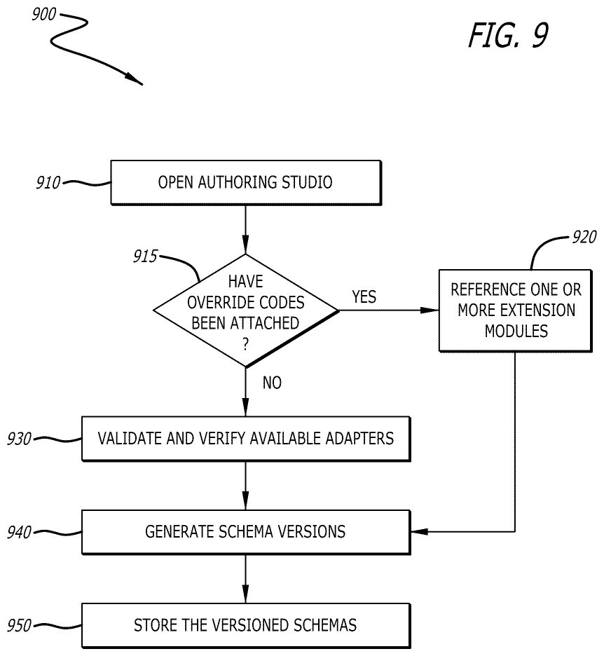

Referring to FIG. 9, a flowchart depicting a process 900 for authoring content and validating extensions, in accordance with various embodiments of the disclosure is shown. In many embodiments, the process 900 can open an authoring studio (block 910). The authoring studio can provide a no-code environment for creating interactive content, including two-dimensional (2D), three-dimensional (3D), and blended presentations. For example, an author may utilize the studio to work with various components, such as scene graphs, interactive panels, and event-based triggers, to compose an immersive experience. It is contemplated that the studio can also provide an interface for developers to attach custom scripts as code overrides for more advanced or specialized functionality.

In a number of embodiments, the process 900 can determine if override codes have been attached (block 915). This can involve checking if any optional extension modules have been linked to the universal schema to add custom, author-defined behavior. If it is determined that override codes have been attached, the process 900 can reference one or more extension modules (block 920). This can involve referencing renderer-agnostic extension interfaces that are designed to provide custom functionality. For instance, adapter checks can later be performed on these referenced modules to ensure safe and consistent behavior across different renderers. However, if it is determined that no override codes have been attached, the process 900 can proceed to validate and verify available adapters (block 930).

In more embodiments, the process 900 can validate and verify available adapters (block 930). This can include performing a series of static checks on the authored content to ensure it complies with established parity and security requirements before it is published. In some embodiments where extension modules are present, the system can also verify that the required renderer-specific adapters for each extension are available for all target renderers. Should a required adapter be missing, the system may be configured to apply a declared fallback behavior to maintain experience stability during runtime.

In further embodiments, the process 900 can generate schema versions (block 940). After the content has been successfully validated, it can be compiled into a versioned universal schema that programmatically captures all the authored structure, assets, and interactive behaviors. As part of this process, a unique version identifier can be assigned to the schema. It is contemplated that this versioning allows for precise tracking and retrieval of different content iterations, which can facilitate A/B testing by allowing different groups of users to be served different versions of the same experience.

In additional embodiments, the process 900 can store the versioned schemas (block 950). The finalized and versioned schema can be stored in a universal store or published to a Content Delivery Network (CDN), where it is ready for delivery to client devices. In some embodiments, the storage process may also generate or update a manifest that lists all the assets associated with the schema version. This manifest can later be used by a client device to optimize the loading and pre-fetching of content required to render the experience.

Although a specific embodiment for a process 900 for authoring content and validating extensions is discussed with respect to FIG. 9, any of a variety of systems and/or processes may be utilized in accordance with embodiments of the disclosure. For example, the validation and verification could occur on a client device as a pre-flight check before submitting the content to a server for versioning and storage. The elements depicted in FIG. 9 may also be interchangeable with other elements of FIGS. 1-8 and 10-13 as required to realize a particularly desired embodiment.

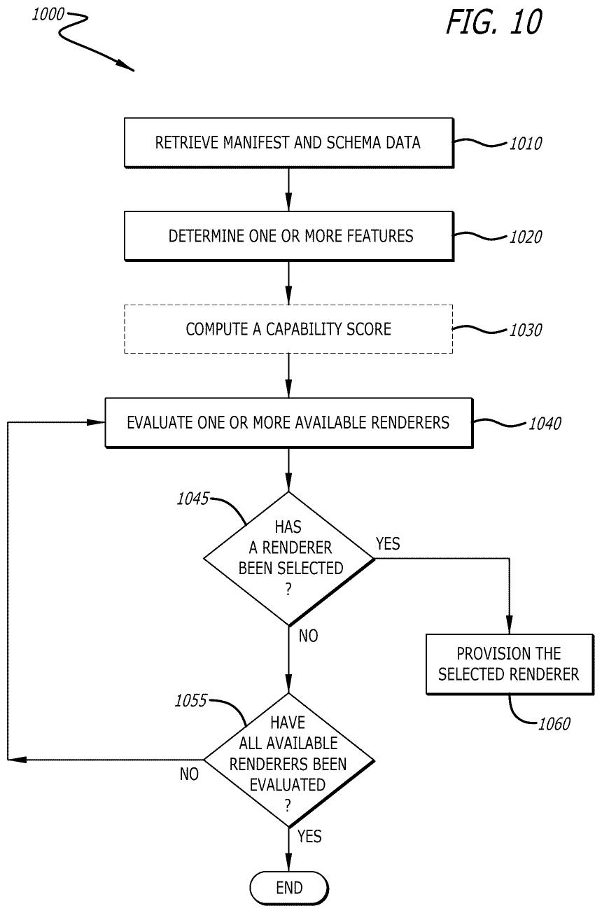

Referring to FIG. 10, a flowchart depicting a process 1000 for client-side renderer selection and provisioning, in accordance with various embodiments of the disclosure is shown. In many embodiments, the process 1000 can retrieve manifest and schema data (block 1010). Upon launching an experience, a client device can download a manifest file and its associated universal schema from a distribution service. For instance, this retrieved data can include metadata about the assets required for the experience, their different variants, and a list of renderers supported by the content. It is contemplated that the manifest can be retrieved first to allow the client device to check for content updates, enabling it to either use a locally cached version of the schema or download a newer one.

In a number of embodiments, the process 1000 can determine one or more features (block 1020). The client device can be configured to assess its own capabilities to create a device profile. This assessment can include determining available rendering Application Programming Interfaces (APIs), identifying hardware such as the GPU model and available memory, and checking for support for extended-reality (XR) sessions. In some embodiments, this determination can also include evaluating environmental factors like current network bandwidth or the device's battery status, which can influence which renderer will provide the most optimal user experience.

In some embodiments, the process 1000 can compute a capability score (block 1030). This can involve calculating a weighted score based on the various device traits and environmental factors determined in the previous operation. For example, a powerful GPU and the presence of XR support could result in a high capability score, while a constrained network connection could lower the score. It is contemplated that this score can be used not only for renderer selection but also to inform subsequent decisions, such as which level-of-detail (LOD) variants of 3D models should be loaded.

In more embodiments, the process 1000 can evaluate one or more available renderers (block 1040). Each available renderer, such as a browser-based web renderer or a native application XR renderer, can be evaluated against the device's capability profile and any policy rules defined in the manifest. The goal of this evaluation can be to find the best match between the device's capabilities and the requirements or preferences of each renderer, ensuring optimal performance and presentation fidelity.

In further embodiments, the process 1000 can determine if a renderer has been selected (block 1045). If a suitable renderer has been selected based on the evaluation, the process 1000 can provision the selected renderer (block 1060). This can involve initializing the chosen renderer on the client device and preparing it to receive the universal schema for mapping and rendering. However, if a suitable renderer has not yet been selected, the process 1000 can determine if all available renderers have been evaluated (block 1055). If unevaluated renderers remain, the process 1000 can loop back to evaluate one or more available renderers (block 1040). If all renderers have been considered and no suitable match is found, the process can end, which in some embodiments may involve applying a final fallback such as displaying a simplified 2D version of the content or an error message.

Although a specific embodiment for a process 1000 for client-side renderer selection and provisioning is discussed with respect to FIG. 10, any of a variety of systems and/or processes may be utilized in accordance with embodiments of the disclosure. For example, the evaluation of renderers could be based entirely on a user's manual selection from a settings menu, bypassing the automated capability assessment. The elements depicted in FIG. 10 may also be interchangeable with other elements of FIGS. 1-9 and 11-13 as required to realize a particularly desired embodiment.

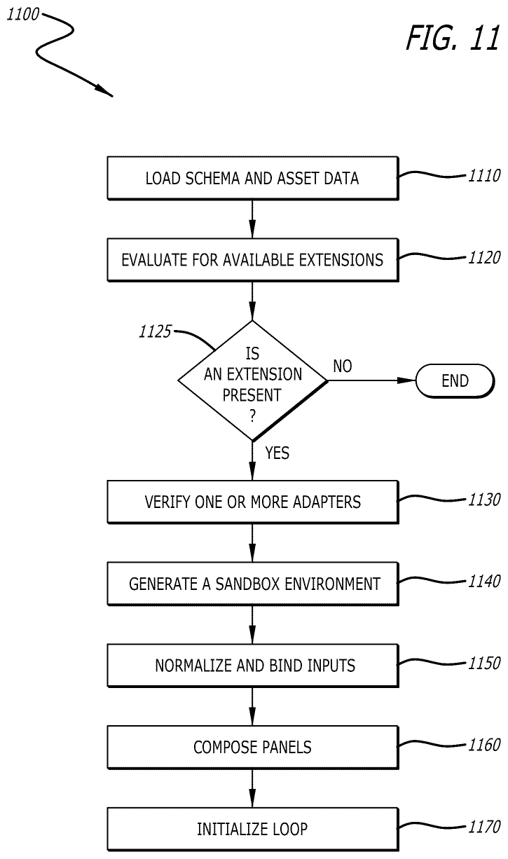

Referring to FIG. 11, a flowchart depicting a process 1100 for mapping a universal schema to a selected renderer, in accordance with various embodiments of the disclosure is shown. In many embodiments, the process 1100 can load schema and asset data (block 1110). The client device can fetch and load the universal schema data and all assets required to render the experience. For instance, this can involve resolving which asset variants or level-of-detail (LOD) settings to use based on a previously computed capability score, ensuring that high-performance devices receive high-fidelity assets while lower-end devices receive more optimized versions. It is contemplated that the loading process may also involve pre-fetching certain assets listed in a manifest to reduce perceived load times for the user.

In a number of embodiments, the process 1100 can evaluate for available extensions (block 1120). The system can be configured to check the loaded schema to determine whether any optional extension modules are present. For example, these extensions may include CustomActions that define unique, author-scripted behaviors or CustomComponents that introduce new types of objects or functionalities into the scene. This evaluation can also identify the specific renderer-agnostic interfaces that the extensions are registered against.

In more embodiments, the process 1100 can determine if an extension is present (block 1125). If it is determined that one or more extensions are present in the schema, the process 1100 can proceed to verify one or more adapters (block 1130). This verification can involve the client checking for the required renderer-specific adapters for each detected extension and also verifying any permissions the extension requires to execute. However, if it is determined that no extensions are present, the process 1100 can end the extension evaluation sub-process.

In further embodiments, the process 1100 can generate a sandbox environment (block 1140). After verifying the necessary adapters and permissions, a secure and isolated execution context can be created to run the extension's logic. It is contemplated that this sandbox environment can restrict the extension's access to the rest of the system, providing it only with specific, capability-gated APIs in order to prevent it from compromising system stability or portability.

In additional embodiments, the process 1100 can normalize and bind inputs (block 1150). The mapping engine can standardize all user input events-such as touch, pointer, gaze, and controller inputs-into a common, unified event format. These normalized inputs can then be bound to the corresponding triggers defined in the universal schema, ensuring that interactions behave consistently across all device types and input modalities to preserve behavioral parity.

In still more embodiments, the process 1100 can compose panels (block 1160). User interface panels defined in the schema can be placed and composed into the scene by the renderer. For instance, panels may be composed as view-anchored overlays that function like a head-up display (HUD), world-anchored elements that exist at a fixed coordinate in the 3D space, or object-anchored elements that are attached to another component in the scene. The layout of these panels can also be made responsive to the device's viewport geometry.

In yet further embodiments, the process 1100 can initialize a loop (block 1170). The rendering loop can be started, at which point the client device begins processing and drawing frames to the display. Once initialized, the loop can continuously process user input, update the state of the experience based on trigger evaluations, and render the scene for the user.

Although a specific embodiment for a process 1100 for mapping a universal schema to a selected renderer is discussed with respect to FIG. 11, any of a variety of systems and/or processes may be utilized in accordance with embodiments of the disclosure. For example, the normalization of inputs could be performed by the renderer itself, which then provides a pre-normalized event stream to the mapping engine. The elements depicted in FIG. 11 may also be interchangeable with other elements of FIGS. 1-10 and 12-13 as required to realize a particularly desired embodiment.

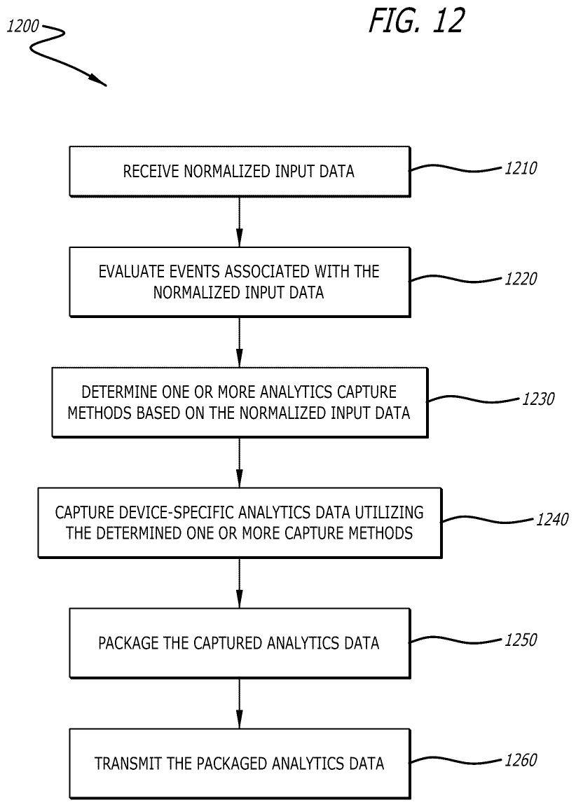

Referring to FIG. 12, a flowchart depicting a process 1200 for handling normalized inputs and emitting analytics, in accordance with various embodiments of the disclosure is shown. In many embodiments, the process 1200 can receive normalized input data (block 1210). All user inputs can be processed through a normalized pipeline to abstract away hardware differences between various client devices. For example, inputs from a touchscreen, a mouse, extended-reality (XR) controllers, or gaze-tracking hardware can all be converted into a common, standardized format before being processed further. It is contemplated that this normalization allows the rest of the system to operate on a single, unified event model, which simplifies the logic required for handling user interactions across a wide range of devices.

In a number of embodiments, the process 1200 can evaluate events associated with the normalized input data (block 1220). The system can check for matching triggers and conditions based on the current state of the immersive experience and the received normalized input data. In some embodiments, this evaluation can be performed on every frame or on a per-interaction basis to determine if a user's action, such as clicking on a panel or looking at a hotspot, should dispatch an action that is defined in the universal schema.

In more embodiments, the process 1200 can determine one or more analytics capture methods based on the normalized input data (block 1230). Based on the type of normalized input and the event that was triggered, the client device can identify the appropriate methods to log the interaction. For instance, a normalized “select” event might trigger a click-capture method, while a continuous stream of normalized gaze data within a geometric zone might trigger a spatial dwell-capture method. It is contemplated that the capture methods themselves can also be defined within the universal schema, allowing content authors to specify precisely how certain interactions should be measured.

In further embodiments, the process 1200 can capture device-specific analytics data utilizing the determined one or more capture methods (block 1240). The analytics can be recorded using device-specific techniques but are immediately serialized into a renderer-agnostic format to ensure consistency across all platforms. For example, a native XR renderer may capture a high-fidelity gaze vector, but that data is then serialized into a standard format that includes a timestamp, a zone identifier, and a duration, which is the same format a web renderer would use to record a mouse hover event.

In additional embodiments, the process 1200 can package the captured analytics data (block 1250). The captured and serialized data can be batched together with additional context, such as session identifiers, user identifiers, timestamps, and spatial context like world coordinates. In some embodiments, packaging the data into batches can help optimize network usage by reducing the number of individual transmissions to a backend service.

In still more embodiments, the process 1200 can transmit the packaged analytics data (block 1260). The final data batches can be sent from the client device to a backend analytics service for processing, aggregation, and insights. It is contemplated that this transmission can occur in near real-time to support live monitoring dashboards or can be deferred until a stable network connection is available in order to preserve device resources such as battery and bandwidth.

Although a specific embodiment for a process 1200 for handling normalized inputs and emitting analytics is discussed with respect to FIG. 12, any of a variety of systems and/or processes may be utilized in accordance with embodiments of the disclosure. For example, the analytics data could be processed and compacted entirely on the client device in a privacy-preserving mode, with only anonymized summaries being transmitted to a server. The elements depicted in FIG. 12 may also be interchangeable with other elements of FIGS. 1-11 and 13 as required to realize a particularly desired embodiment.

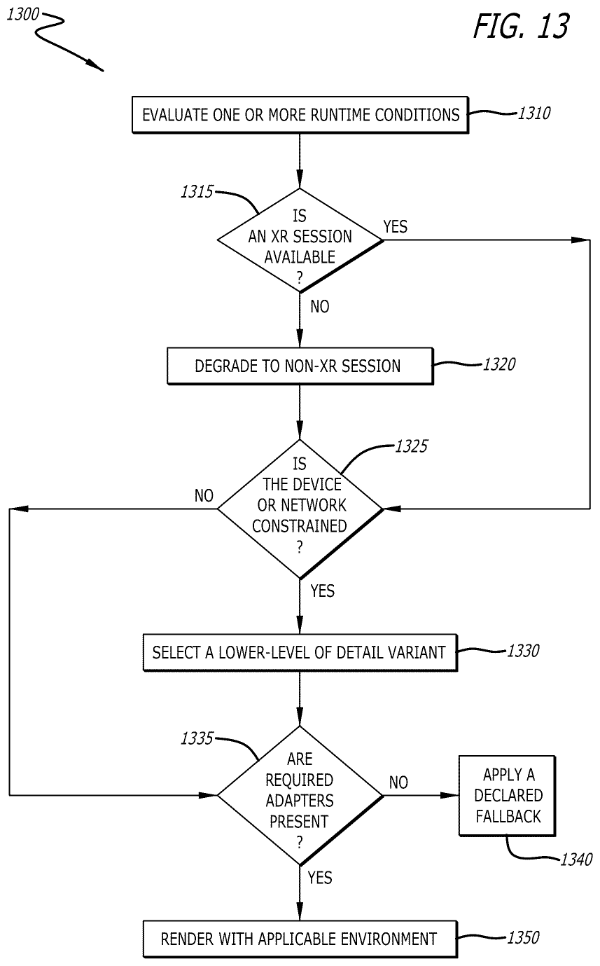

Referring to FIG. 13, a flowchart depicting a process 1300 for runtime adaptation and applying fallbacks, in accordance with various embodiments of the disclosure is shown. In many embodiments, the process 1300 can evaluate one or more runtime conditions (block 1310). Before or during the rendering of an experience, the client device can assess a variety of runtime variables to ensure an optimal presentation. For instance, these variables can include the availability of an extended-reality (XR) session, current device performance constraints like battery level or thermal state, and network connectivity status. It is contemplated that this evaluation can be performed once upon initialization or continuously throughout the user's session to allow the experience to adapt dynamically to changing conditions.

In a number of embodiments, the process 1300 can determine if an XR session is available (block 1315). If an XR session is not supported or active on the client device, the process 1300 can degrade to a non-XR session (block 1320). This can involve the system automatically falling back to a two-dimensional (2D) or less immersive mode. For example, a fully spatial architectural walkthrough could be presented as a 3D model viewer within a standard 2D webpage, while crucially preserving the core interaction logic to maintain behavioral parity. However, if it is determined that an XR session is available, the process 1300 can proceed with immersive rendering while evaluating further constraints.

In more embodiments, the process 1300 can determine if the device or network is constrained (block 1325). If it is determined that a performance constraint exists, such as low battery, high CPU temperature, or limited network bandwidth, the process 1300 can select a lower-level of detail variant (block 1330). This can involve selecting lower-quality assets, using simpler visual effects, or deferring the loading of non-critical content to ensure smooth performance on the device. For instance, the system might choose to load 2K textures instead of 4K textures if low memory is detected. However, if it is determined that the device and network are not constrained, the process 1300 can proceed using high-fidelity assets.

In further embodiments, the process 1300 can determine if required adapters are present (block 1335). If it is determined that a required software adapter for an extension is not available for the chosen renderer, the process 1300 can apply a declared fallback (block 1340). The system can be configured to apply pre-defined fallback logic, such as disabling the custom feature or replacing it with a standard component, in order to maintain the stability of the experience. In some embodiments, the fallback may be a no-op, where the extension is simply ignored. However, if it is determined that all required adapters are present, the process 1300 can proceed to the final rendering.

In additional embodiments, the process 1300 can render with the applicable environment (block 1350). Finally, the client device can render the immersive experience using the chosen renderer and with all the determined optimizations and fallbacks in place. It is contemplated that this final rendered environment is the result of the preceding series of checks, ensuring that the user is provided with the most optimal experience possible given their specific device, network, and software capabilities.

Although a specific embodiment for a process 1300 for runtime adaptation and applying fallbacks is discussed with respect to FIG. 13, any of a variety of systems and/or processes may be utilized in accordance with embodiments of the disclosure. For example, the adaptation logic could also account for user preferences, allowing a user to manually override the automated settings to force a high-fidelity mode even on a constrained device. The elements depicted in FIG. 13 may also be interchangeable with other elements of FIGS. 1-12 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
an immersive web logic stored in the memory and executable by the processor, the immersive web logic configured to:
retrieve a runtime-agnostic universal schema;
determine one or more capabilities of the device;
select a renderer based on the one or more capabilities;
translate the universal schema into one or more renderer-specific primitives for the selected renderer;
normalize a plurality of input types received from the selected renderer into a common event format;
generate renderer-agnostic analytics data based on the common event format; and
transmit the renderer-agnostic analytics data.

2. The device of claim 1, wherein the translation of the universal schema preserves behavioral parity across a plurality of heterogeneous renderers.

3. The device of claim 1, wherein the renderer is selected from a plurality of heterogeneous renderers.

4. The device of claim 3, wherein the plurality of heterogeneous renderers comprises at least a web renderer and a native extended-reality (XR) renderer.

5. The device of claim 4, wherein the immersive web logic is further configured to:
determine if an extended-reality (XR) session is available as one of the one or more capabilities;
wherein the selected renderer is the native XR renderer in response to determining the XR session is available, and wherein the selected renderer is the web renderer in response to determining the XR session is unavailable.

6. The device of claim 1, wherein the runtime-agnostic universal schema is configured to define one or more assets.

7. The device of claim 6, wherein the one or more assets comprise at least a two-dimensional (2D) presentation, a three-dimensional (3D) presentation, and a blended 2D-to-3D presentation.

8. The device of claim 7, wherein the blended 2D-to-3D presentation, when rendered by an extended-reality (XR) renderer, comprises one or more 3D assets rendered as a spatial environment and one or more 2D assets rendered as a view-anchored overlay.

9. The device of claim 1, wherein the renderer-agnostic analytics data is based on the universal schema.

10. The device of claim 1, wherein the renderer-agnostic analytics data comprises a spatial analytic, and wherein generating the spatial analytic comprises performing an intersection test between a spatial input type and a geometric zone defined in the universal schema.

11. The device of claim 1, wherein determining the one or more capabilities further comprises computing a capability score based on at least one of a graphics feature, network quality, or a thermal state of the device, and wherein the renderer is selected based on the capability score.

12. The device of claim 1, wherein the plurality of input types comprises at least one of a pointer event, a touch event, a gaze event, or a controller event.

13. A method for providing cross-platform delivery of immersive content, the method comprising:
retrieving, via a client-side device, a runtime-agnostic universal schema from a server-side device;
determining one or more capabilities of the client-side device;
selecting a renderer based on the one or more capabilities;
translating the universal schema into one or more renderer-specific primitives for the selected renderer;
normalizing a plurality of input types associated with the client-side device;
generating renderer-agnostic analytics data based on the normalized plurality of input types; and
transmitting the renderer-agnostic analytics data to the server-side device.

14. The method of claim 13, wherein the plurality of input types are received from the selected renderer.

15. The method of claim 14, wherein the plurality of input types are normalized into a common event format.

16. The method of claim 15, wherein renderer-agnostic analytics data is based on the common event format.

17. The method of claim 13, wherein the renderer is selected from a plurality of heterogeneous renderers.

18. The method of claim 17, wherein translating the universal schema preserves behavioral parity across the plurality of heterogeneous renderers.

19. The method of claim 13, wherein the universal schema defines at least a two-dimensional (2D) presentation, a three-dimensional (3D) presentation, and a blended 2D-to-3D presentation.

20. The method of claim 19, wherein the blended 2D-to-3D presentation comprises rendering one or more 3D assets as a spatial environment and rendering one or more 2D assets as a view-anchored overlay within an extended-reality (XR) session.
